(19) United States
(12) Patent Application Publication
(10) Pub. No.: US 2020/0349597 A1
(43) Pub. Date: Nov. 5, 2020

(54) SHOPPING MANAGEMENT CONTROL SYSTEM BASED ON ACQUAINTANCE DISCOUNT CODE AND SHOPPING MANAGEMENT CONTROL METHOD BASED ON ACQUAINTANCE DISCOUNT CODE

(71) Applicant: D-UNIT CO., LTD., Seoul (KR)

(72) Inventors: Ban Seok YOON, Gyeonggi-do (KR); Cheol Yeon HWANG, Seoul (KR)

(73) Assignee: D-UNIT CO., LTD., Seoul (KR)

(21) Appl. No.: 16/587,703

(22) Filed: Sep. 30, 2019

(30) Foreign Application Priority Data
May 2, 2019 (KR) 10-2019-0051825

(51) Int. Cl. G06Q 30/02; G06Q 30/06

(52) U.S. Cl. CPC G06Q 30/0214; H04W 88/02; G06Q 30/0222; G06Q 30/0641

(57) ABSTRACT

A shopping management control system based on an acquaintance discount code includes an input controller configured to recognize information in an acquaintance discount code to be provided by a user according to an input of the user; a management controller configured to determined that the the input controller recognized the information to generate an acquaintance discount code of the user and store and manage the acquaintance discount code of the user; a display controller configured to display the acquaintance discount code of the user generated through the management controller on a screen of a terminal of a user; and a feedback controller configured to feed back, when the acquaintance discount code of the user is received and an item is purchased by using the acquaintance discount code, one or more pieces of application information of the acquaintance discount code to the user.

### CROSS-REFERENCE TO RELATED APPLICATION

This application claims the benefit of Korean Patent Application No. 10-2019-0051825, filed on May 2, 2019, in the Korean Intellectual Property Office, the disclosure of which is incorporated herein in its entirety by reference.

### BACKGROUND

### 1. Field

One or more embodiments relate to a shopping management control system based on an acquaintance discount code and a shopping management control method based on an acquaintance discount code.

### 2. Description of Related Art

Currently, users may obtain information about various items in text or graphic form. For example, users may obtain information about an item through a screen of a terminal.

There are many types of users' terminals. Due to the technological development in recent years, users may obtain through a screen of a portable terminal information about a greater number of items than in the past.

Also, technological advances may allow users to access many types of shopping websites to select and purchase various items.

However, accessing an appropriate shopping website based on information of many shopping websites is not easy. In addition, confirming the shopping tendency of an acquaintance that has a relationship with a user or confirming information on a shopping website that is frequently used is not easy. Therefore, there is a need to improve the shopping convenience of users.

### SUMMARY

One or more embodiments include a shopping management control system based on an acquaintance discount code and a shopping management control method based on an acquaintance discount code, the system and the method improving the shopping convenience of a user to generate the acquaintance discount code and the shopping convenience of an acquaintance using the acquaintance discount code.

Additional aspects will be set forth in part in the description which follows and, in part, will be apparent from the description, or may be learned by practice of the presented embodiments of the disclosure

According to one or more embodiments, a shopping management control system based on an acquaintance discount code includes an input controller recognizing information included in an acquaintance discount code to be provided by a user according to an input of the user; a management controller reflecting the recognition of the input controller to generate an acquaintance discount code of the user and storing and managing the acquaintance discount code of the user; a display controller displaying the acquaintance discount code of the user generated through the management controller on a screen of a terminal of a user; and a feedback controller feeding back, when the acquaintance discount code of the user is received and an item is purchased by applying the acquaintance discount code, application information of the acquaintance discount code to the user through one or more information.

According to an embodiment, the acquaintance discount code may be used in a shopping-providing website, and the display controller may display information of the acquaintance discount code of the user on one page among a plurality of pages of the shopping-providing website.

According to an embodiment, when the acquaintance discount code is applied to purchase an item, the feedback controller may include providing a rewarding revenue to the user.

According to an embodiment, the acquaintance discount code may be used in a shopping-providing website, and an input area inputting the acquaintance discount code may be displayed on one page among a plurality of pages of the shopping-providing website.

According to an embodiment, the system may further include a reception display controller displaying information of the acquaintance discount code on a screen of a terminal of an acquaintance of the user, the acquaintance receiving the acquaintance discount code.

According to one or more embodiments, a shopping management control method based on an acquaintance discount code includes an input controlling operation recognizing information included in an acquaintance discount code to be provided by a user according to an input of the user; a management controlling operation reflecting the recognition in the input controlling operation to generate an acquaintance discount code of the user and storing and managing the acquaintance discount code of the user; a display controlling operation displaying the acquaintance discount code of the user generated through the management controlling operation on a screen of a terminal of a user; and a feedback controlling operation feeding back, when the acquaintance discount code of the user is received and an item is purchased by applying the acquaintance discount code, application information of the acquaintance discount code to the user through one or more information.

According to an embodiment, the acquaintance discount code may be used in a shopping-providing website, and the display controlling operation may display information of the acquaintance discount code of the user on one page among a plurality of pages of the shopping-providing website.

According to an embodiment, when the acquaintance discount code is used to purchase an item, the feedback controlling operation may include providing rewarding revenue to the user.

According to an embodiment, the acquaintance discount code may be used in a shopping-providing website, and an input area inputting the acquaintance discount code may be displayed on one page among a plurality of pages of the shopping-providing website.

According to an embodiment, the method may further include a reception display controlling operation displaying information of the acquaintance discount code on a screen of a terminal of an acquaintance of the user, the acquaintance receiving the acquaintance discount code.

A computer-readable recording medium having recorded thereon a program performing any one of the above methods.

Other aspects, features, and advantages other than those described above will now become apparent from the following drawings, claims, and the detailed description of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a shopping management control system based on an acquaintance discount code according to an embodiment;

FIG. 2 is a diagram of an information transmission controller which may be added to the shopping management control system based on an acquaintance discount code in FIG. 1, according to an embodiment;

FIG. 3 is a diagram of the information transmission controller in FIG. 2, according to an embodiment;

FIG. 4 is a diagram of a reception display controller which may be added to the shopping management control system based on an acquaintance discount code in FIG. 1, according to an embodiment;

FIG. 5 is a diagram of a code input receiving unit and a discount applying unit which may be added to the shopping management control system based on an acquaintance discount code in FIG. 1, according to an embodiment;

FIG. 6 is a diagram of the code input receiving unit in FIG. 5, according to an embodiment;

FIG. 7 is a diagram of a feedback controller of the shopping management control system based on an acquaintance discount code in FIG. 1, according to an embodiment;

FIG. 8 is a diagram of a display controller of the shopping management control system based on an acquaintance discount code in FIG. 1, according to an embodiment;

FIGS. 9 to 11 are diagrams of examples of a network connection of a shopping management control system based on an acquaintance discount code according to an embodiment;

FIG. 12 is a schematic diagram of a shopping management control method based on an acquaintance discount code according to an embodiment;

FIG. 13 is a diagram of an information transmission controlling operation which may be added to the shopping management control method based on an acquaintance discount code in FIG. 12, according to an embodiment;

FIG. 14 is a diagram of the information transmission controlling operation in FIG. 13, according to an embodiment;

FIG. 15 is a diagram of a reception display controlling operation which may be added to the shopping management control method based on an acquaintance discount code in FIG. 12, according to an embodiment;

FIG. 16 is a diagram of a code input receiving operation and a discount applying operation which may be added to the shopping management control method based on an acquaintance discount code in FIG. 12, according to an embodiment;

FIG. 17 is a diagram of a code input receiving operation in FIG. 16, according to an embodiment;

FIG. 18 is a diagram of a feedback controlling operation of the shopping management control method based on an acquaintance discount code in FIG. 12, according to an embodiment;

FIG. 19 is a diagram of a display controlling operation of the shopping management control method based on an acquaintance discount code in FIG. 12, according to an embodiment; and

FIGS. 20 to 30 are diagrams of a shopping management control method based on an acquaintance discount code according to an embodiment.

### DETAILED DESCRIPTION OF EMBODIMENTS

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Sizes of components in the drawings may be exaggerated for convenience of explanation. In other words, since sizes and thicknesses of components in the drawings are arbitrarily illustrated for convenience of explanation, the following embodiments are not limited thereto.

In the following embodiments, the x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

When a certain embodiment may be implemented differently, a specific process order may be performed differently from the described order. For example, two consecutively described processes may be performed substantially at the same time or performed in an order opposite to the described order.

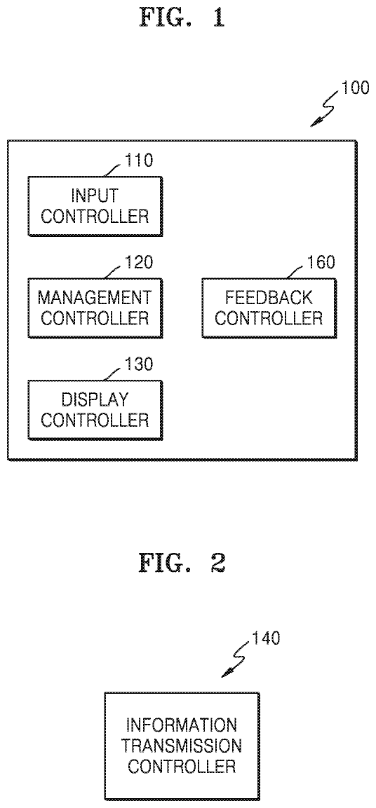

FIG.1 is a schematic diagram of a shopping management control system 100 based on an acquaintance discount code according to an embodiment.

Referring to FIG. 1, the shopping management control system 100 based on an acquaintance discount code may include an input controller 110, a management controller 120, a display controller 130, and a feedback controller 160.

The shopping management control system 100 based on an acquaintance discount code of the present embodiment may be used by a plurality of users. The shopping management control system 100 based on an acquaintance discount code may be used by one user and more than one acquaintances of the one user. Accordingly, an acquaintance discount code of the one user may be used by an acquaintance such as a friend of the one user to apply a discount to buy an item on a shopping webpage.

The shopping management control system 100 based on an acquaintance discount code of the present embodiment will now be described in more detail.

The input controller 110 may recognize, according to a user's input, a piece of information included in an acquaintance discount code to be provided by a user.

In an embodiment, the user may input the piece of information included in the acquaintance discount code in a text form and the text may be recognized by the input controller 110.

In an embodiment, the input controller 110 may display a text input window on a screen of a user's terminal and recognize a character when the user inputs the character on the text input window.

In an embodiment, the input controller 110 may display a selection control window and the selection control window may include various information blocks such as a plurality of characters, figures, pictures which may all be selected by the user. When the user selects the information block, for example, according to a touch of the block, the block may be recognized as an acquaintance discount code.

In another embodiment, the input controller 110 may recognize that the user sequentially selected a plurality of blocks, which are sequentially connected, through the selection control window and information included in each block as an acquaintance discount code.

Accordingly, the user's input convenience may be improved.

The management controller 120 may generate an acquaintance discount code of the user by reflecting the recognition of the input controller 110 and store or manage the acquaintance discount code.

The management controller 120 may generate acquaintance discount code by using the information of the user first recognized through the input controller 110. In an embodiment, the management controller 120 may generate the same information as the text input by the user through the input controller 110 as an acquaintance discount code. According to a particular example, the management controller 120 may generate an acquaintance discount code by distinguishing between individual letters and spaces between letters or distinguishing between uppercase and lowercase letters.

According to an embodiment, the generated acquaintance discount code may be stored by using the management controller 120 and may be stored in the user's terminal. According to another example, the generated acquaintance discount code may be stored in a server separate from the user's terminal or a storage unit connected to the server.

In an embodiment, the management controller 120 may reflect a modification item to change the acquaintance discount code of the user when the user wants to modify the acquaintance discount code of the user, for example, the management controller 120 may reflect real-time modification items to update the acquaintance discount code of the user.

In this case, the modification of the acquaintance discount code of the user may be performed through the input controller 110, for example, the modification may be performed by using the text input window or the like.

The display controller 130 may display the acquaintance discount code of the user generated through the management controller 120 on a screen of the user's terminal.

The user may view the acquaintance discount code displayed through the display controller 130, and thus, the user may easily check the user's acquaintance discount code generated by the user's input.

In an embodiment, the user may check the acquaintance discount code on a page of a shopping-providing website in the screen of the user's terminal and the display controller 130 may display the acquaintance discount code on a personal information page of the user among a plurality of pages of the shopping-providing website. In addition, according to another example, the display controller 130 may display the acquaintance discount code of the user on a first page that is displayed when the user logins among the plurality of pages of the shopping-providing website.

In addition, in an embodiment, the display controller 130 may display feedback information when the acquaintance of the user receives the acquaintance discount code of the user to purchase one or more items, for example, a purchase breakdown of the acquaintance may be displayed.

In addition, in a further embodiment, the display controller 130 may display the feedback information when the acquaintance of the user receives the acquaintance discount code of the user to purchase one or more items, for example, rewarding revenue that the user receives according to the purchase of the acquaintance may be displayed. According to a particular example, the rewarding revenue detailed breakdown and the reward income accumulation information may be displayed.

When an item is purchased by receiving and using the acquaintance discount code of the user, the feedback controller 160 may feed one or more pieces of application information of the acquaintance discount code back to the user.

For example, when an item is purchased by using the acquaintance discount code of the user, the feedback controller 160 may allow the user to check purchase history information purchasing the item by using the acquaintance discount code of the user.

When one of the persons other than the user tries to apply the acquaintance discount code of the user on the shopping-providing website, according to a particular example, when an input is completed in a discount code input window, information with respect to the input may be informed to the user.

In an embodiment, when the one of the persons other than the user applies the acquaintance discount code of the user on the shopping-providing website, according to a particular example, when an input is completed in the discount code input window, information with respect to the input may be transmitted to the user through a message, and according to an embodiment, the information with respect to the input may be transmitted immediately after the input is completed.

According to another embodiment, when the one of the persons other than the user applies the acquaintance discount code of the user on the shopping-providing website, according to a particular example, when an input is completed in the discount code input window, information with respect to the input may be displayed on the screen of the user's terminal, for example, the above-stated display controller 130 may be used to display the information with respect to the input.

In addition, according to an embodiment, when a plurality of acquaintances apply the acquaintance discount code of the user on the shopping-providing website or when one of the acquaintance applies the acquaintance discount code of the user on the shopping-providing website when purchasing a plurality of items, a plurality of purchase histories purchased by applying the acquaintance discount code of the user may be displayed on the screen of the user's terminal.

The user may easily figure out a use state of the acquaintance discount code of the user by checking various information and may figure out a tendency of the acquaintances by easily figuring out the purchases of the acquaintances, and also may actively share acquaintance discount codes.

According to another embodiment, when a person other than the user, for example, an acquaintance such as a friend of the user uses the acquaintance discount code of the user to purchase an item, the feedback controller may provide a rewarding revenue to the user and may display the rewarding revenue on the screen of the user's terminal to allow the user to check.

According to an embodiment, when one of the persons other than the user applies the acquaintance discount code of the user on the shopping-providing website, according to a particular example, when an input is completed in the discount code input window, a predetermined rewarding revenue may be provided to the user and displayed on the screen of the user's terminal.

According to an embodiment, a payment of the reward to the user may be completed after going through a payment schedule stage, for example, when other person uses the acquaintance discount code of the user to decide to purchase an item, it is set to a “reward payment schedule stage”. When the other person completes a final normal payment, the “reward payment schedule stage” is changed to a “reward payment completion” stage and actual rewarding revenue may be paid to the user. In addition, processes of each stage may be distinguished according to time and may be displayed on the screen of the user's terminal.

According to a particular example, various contents related to the rewarding revenue may be displayed by using the above-stated display controller 130.

In addition, according to an embodiment, when the plurality of acquaintances apply the acquaintance discount code on the shopping-providing website or when one of the acquaintances applies the acquaintance discount code on the shopping-providing website when purchasing a plurality of items, a plurality of rewarding revenue histories may be sequentially displayed to allow the user to check and the user may check an accumulative rewarding revenue over a certain period of time. According to an example, the rewarding revenue history and the accumulative rewarding revenue may be displayed on the screen of the user's terminal by using the display controller 130.

FIG. 2 is a diagram of an information transmission controller 140 which may be added to the shopping management control system based on an acquaintance discount code in FIG. 1, according to an embodiment.

Referring to FIG. 2, the shopping management control system based on an acquaintance discount code according to the present embodiment may further include the information transmission controller 140.

The user may transmit his/her acquaintance discount code to other persons through the information transmission controller 140. For example, the user may transmit information of the acquaintance discount code generated by the user to one or more or a plurality of acquaintances through the information transmission controller 140. Other persons who received the information of the acquaintance discount code of the user through the information transmission controller 140 may use the acquaintance discount code of the user to purchase a desired item at a discount prince according to a set discount rate.

According to an embodiment, the information transmission controller 140 may transmit the acquaintance discount code of the user to another person through the user's terminal and respectively transmitted to desired acquaintances, according to another example, the acquaintance discount code of the user may be simultaneously transmitted to a plurality of acquaintances.

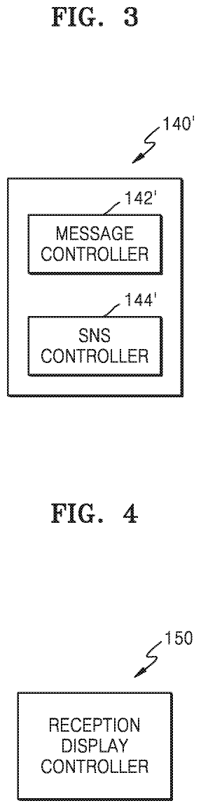

FIG. 3 is a diagram of the information transmission controller in FIG. 2 according to an embodiment.

Referring to FIG. 3, an information transmission controller 140′ may include a message controller 142′ or a social network services (SNS) controller 144′.

The message controller 142′ may transmit the acquaintance discount code to another person in a form of a message.

For example, the user may use the user's terminal to include the acquaintance discount code of the user into a message and transmit the message through the message controller 142′. In this case, the message controller 142′ may include a text input unit to recognize the acquaintance discount code of the user when the acquaintance discount code of the user is input in a form of a text.

According to an embodiment, when the user intends to choose an option to transmit the acquaintance discount code, after choosing only the user's desired acquaintances, the message controller 142′ may transmit the acquaintance discount code information to the desired acquaintances without a text input of the acquaintance discount code, thereby, improving the user's convenience.

The SNS controller 144′ may allow an SNS acquaintance of the user to transmit the acquaintance discount code to another person. According to an embodiment, the SNS controller 144′ may transmit the acquaintance discount code to another person through one or more of a plurality of SNSs in which the user is active.

For example, the user may transmit the information of the acquaintance discount code generated by the user to acquaintances who have a relationship with the user in one or more SNSs through the SNS controller 144′. In this case, the acquaintance discount code may be directly transmitted to the acquaintances without a text input included in the information of the acquaintance discount code of the user such that the acquaintances may check the acquaintance discount code on the SNS controller 144′.

FIG. 4 is a diagram of a reception display controller 150 which may be added to the shopping management control system based on an acquaintance discount code in FIG. 1, according to an embodiment.

Referring to FIG. 4, the shopping management control system based on an acquaintance discount code of the present embodiment may further include the reception display controller 150.

When the user transmits the acquaintance discount code of the user generated by the user to at least one person, for example, an acquaintance, the reception display controller 150 may display a fact of the transmission on the screen of the user's terminal.

For example, the reception display controller 150 may originally display the acquaintance discount code generated by the user on the screen of an acquaintance's terminal.

According to an embodiment, the reception display controller 150 may display information of a shopping-providing website, which may receive discount on an item by applying the information of the acquaintance discount code, on the screen of the acquaintance's terminal. According to a particular example, the reception display controller 150 may display a link area connected to one page among a plurality of pages of a shopping-providing website such that the acquaintance may select the link area to immediately move to a screen of the shopping-providing website to check items that may be able to be purchased from the shopping-providing website.

Accordingly, the acquaintance who has received the acquaintance discount code from the user may easily check the information of the acquaintance discount code and may easily figure out website information that may receive discount on an item by using the acquaintance discount code. In addition, usage convenience with respect to the acquaintance discount code may be improved such that a discount application of an acquaintance may be easy and shopping convenience may be improved.

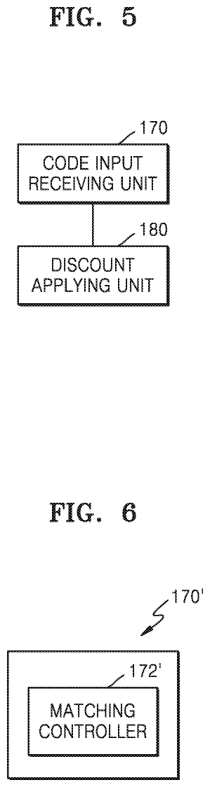

FIG. 5 is a diagram of a code input receiving unit 170 and a discount applying unit 180 which may be added to the shopping management control system based on an acquaintance discount code in FIG. 1.

Referring to FIG. 5, the shopping management control system based on an acquaintance discount code of the present embodiment may further include the code input receiving unit 170 and the discount applying unit 180.

The acquaintance of the user who has received the acquaintance discount code generated by the user may use the acquaintance discount code when purchasing an item on a shopping website. According to a particular example, discounts may be received by applying the acquaintance discount code.

In this case, the acquaintance who intends to use the acquaintance discount code of the user may need to input the acquaintance discount code during a purchase stage when purchasing an item on the shopping website and the code input receiving unit 170may receive and recognize the input of the acquaintance discount code of the user.

For example, the code input receiving unit 170 may recognize an input content when the acquaintance of the user inputs the acquaintance discount code of the user in which the acquaintance knows in the text input window in a text form.

When the acquaintance uses the acquaintance discount code on the shopping website to perform the purchase stage with respect to an item, the discount applying unit 180 may apply a discount rate corresponding to the acquaintance discount code on the one item to perform the purchase stage with a discount price.

In this case, the discount rate may be a preset discount rate, for example, 5% of an original selling price of an item.

According to an embodiment, the discount rate may be changed from the present discount rate when a condition is satisfied. For example, the discount rate may be increased according to accumulative revenue of the user who generates the acquaintance discount code. In detail, when items purchased by applying the acquaintance discount code of the user increase, a preset incremental discount rate may be applied.

FIG. 6 is a diagram of a code input receiving unit 170′ in FIG. 5 according to an embodiment.

Referring to FIG. 6, the code input receiving unit 170′ of the shopping management control system based on an acquaintance discount code of the present embodiment may include a matching controller 172′. The matching controller 172′ may figure out whether an acquaintance discount code input by the acquaintance is normal. According to another example, the matching controller 172′ may figure out whether the input is an acquaintance discount code or an acquaintance discount code generated by the user.

The acquaintance of the user who has received the acquaintance discount code generated by the user may use the acquaintance discount code when purchasing an item on a shopping website. According to a particular example, discounts may be received by applying the acquaintance discount code.

In this case, the acquaintance who intends to use the acquaintance discount code of the user may need to input the acquaintance discount code during the purchase stage when purchasing an item on the shopping website and the code input receiving unit 170′ may receive and recognize the input of the acquaintance discount code of the user.

For example, the code input receiving unit 170′ may recognize an input content when the acquaintance of the user inputs the acquaintance discount code of the user in which the acquaintance knows in the text input window in a text form.

In this case, the matching controller 172′ may determine whether the information input by the acquaintance is the acquaintance discount code. According to an embodiment, the matching controller 172′ may determine whether the information input by the acquaintance matches one of a plurality of acquaintance discount codes which are pre-stored. According to an embodiment, the matching controller 172′ may use characters of the input information matches, spaces between characters, or distinguish between lowercase and upper case letters to determine whether the input information is an acquaintance discount code.

In addition, according to an embodiment, a matching result may be displayed on the screen of the acquaintance's terminal after the input is completed, for example, when the input information does not match the acquaintance discount code, a result may be displayed to notify that a discount may not be applied.

In addition, according to an embodiment, the matching controller 172′ may determine whether the information input by the acquaintance is the acquaintance discount code information generated by the acquaintance own. In this case, the matching result may be displayed on the screen of the acquaintance's terminal. For example, the matching result may be displayed as a notice that the acquaintance inputs his/her acquaintance discount code or a notice that a discount may not be applied may be displayed.

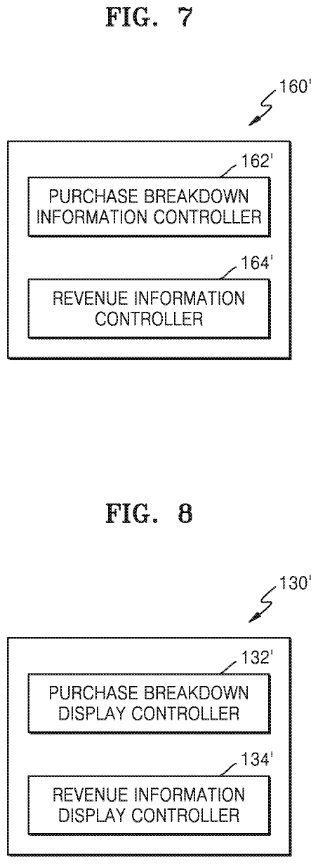

FIG. 7 is a diagram of an embodiment of a feedback controller 160′ of the shopping management control system based on an acquaintance discount code in FIG.

Referring to FIG. 7, the feedback controller 160′ may include a purchase breakdown information controller 162′ and a revenue information controller 164′.

According to an embodiment, the feedback controller 160′ may include one of the purchase breakdown information controller 162′ and the revenue information controller 164′.

When the acquaintance discount code generated by the user is used by a person other than the user, for example, an acquaintance and when the acquaintance uses the acquaintance discount code to apply a discount to purchase an item, the purchase breakdown information controller 162′ may manage and store information with respect to the purchase breakdown. According to an embodiment, the information with respect to the purchase breakdown may be notified to the user, for example, the information with respect to the purchase breakdown may be displayed on the screen of the user's terminal. Accordingly, the user may easily figure out how much of the acquaintance's purchase was made by using the acquaintance discount code generated by the user or who of the acquaintances purchases items by using the acquaintance discount code.

When the acquaintance discount code generated by the user is used by a person other than the user, for example, an acquaintance and when the acquaintance uses the acquaintance discount code to apply a discount to purchase an item, the revenue information controller 164′ may control providing a preset rewarding revenue to the user. Accordingly, the user may be more actively transmit his/her acquaintance discount code to the acquaintances. Accordingly, when more acquaintances apply the acquaintance discount code of the user, the rewarding revenue may be increased.

According to an embodiment, the revenue information controller 164′ may allow a payment of the reward to be completed at one time. According to another example, the revenue information controller 164′ may allow the payment of the reward to the user to be completed after a payment schedule stage.

For example, when another person determines to use the acquaintance discount code of the user to purchase an item, it may be set as a “reward payment schedule stage” and after a final normal payment of the other person is completed, the “reward payment schedule stage” may be changed to a “reward payment completion” stage and an actual rewarding revenue may be paid to the user. In addition, processes of each stage may be distinguished according to time and may be displayed on the screen of the user's terminal.

As a result, the shopping convenience on shopping websites may be improved and shopping opportunities may be increased to increase purchase of items on the shopping websites.

FIG. 8 is a diagram of a display controller 130′ of the shopping management control system based on an acquaintance discount code in FIG. 1 according to an embodiment.

Referring to FIG. 8, the display controller 130′ may include a purchase breakdown display controller 132′ and a revenue information display controller 134′.

According to an embodiment, the display controller 130′ may include one of the purchase breakdown display controller 132′ and the revenue information display controller 134′.

When the acquaintance discount code generated by the user is used by a person other than the user, for example, an acquaintance and when the acquaintance uses the acquaintance discount code to apply a discount to purchase an item, the purchase breakdown display controller 132′ may manage information with respect to the purchase breakdown, according to an embodiment, the purchase breakdown display controller 132′ may display the information with respect to the purchase breakdown on the screen of the user's terminal.

Accordingly, the user may easily figure out how much of the purchase was made by using the acquaintance discount code generated by the user or who of the acquaintances purchases items by using the acquaintance discount code.

According to an embodiment, the purchase breakdown display controller 132′ may display a list of the purchase breakdown on the screen of the user's terminal and may display an accumulative result of the purchase breakdown in a certain period.

When the acquaintance discount code generated by the user is used by a person other than the user, for example, an acquaintance and when the acquaintance uses the acquaintance discount code to apply a discount to purchase an item, preset rewarding revenue may be provided to the user.

According to an embodiment, payment of the reward may be completed at one time. According to another example, the payment of the reward to the user may be completed after the payment schedule stage.

For example, when another person determines to use the acquaintance discount code of the user to purchase an item, it may be set as a “reward payment schedule stage” and after a final normal payment of the other person is completed, the “reward payment schedule stage” may be changed to a “reward payment completion” stage and an actual rewarding revenue may be paid to the user. In addition, processes of each stage may be distinguished according to time and may be displayed on the screen of the user's terminal.

As a result, the shopping convenience on the shopping websites may be improved and the shopping opportunities may be increased to increase purchase of items on the shopping websites.

In addition, the revenue information display controller 134′ may display the rewarding revenue on the screen of the user's terminal to allow the user to check.

According to an example, when one of the persons other than the user applies the acquaintance discount code on the shopping-providing website, according to a particular example, when an input is completed in the discount code input window, predetermined rewarding revenue may be provided to the user and displayed on the screen of the user's terminal.

In addition, when the rewarding revenue is paid to the user stage by stage, the rewarding revenue for each stage may be distinguished and displayed on the screen of the user's terminal through the revenue information display controller 134′.

In addition, an accumulative breakdown of the rewarding revenue may be displayed in accordance with time through the revenue information display controller 134′.

In addition, according to an embodiment, the rewarding revenue may be displayed in connection with a type of purchase, that is, a type of a purchase by the acquaintance.

The shopping management control system based on an acquaintance discount code of the present embodiment may include an input controller to recognize the user's acquaintance discount code input by the user and a management controller may use the recognized content to generate and manage an acquaintance discount code of the user.

In addition, a display controller may display the acquaintance discount code of the user through the screen of the user's terminal to allow the user to check. Accordingly, the user may easily check the acquaintance discount code input and generated by the user and may check the displayed content to make modification when needed.

When another person uses the acquaintance discount code of the user to receive a discount to purchase an item, feedback reflecting information about the purchase may be performed through a feedback controller. For example, feedback of information with respect to a purchase may be performed and feedback of information with respect to rewarding revenue that the user may obtain through the purchase may be performed. In this case, according to an embodiment, the feedback content may be displayed on the screen of the user's terminal and the user may easily figure out use of the acquaintance discount code of the user and a revenue content of the user with respect to the use of the acquaintance discount code.

In addition, according to an embodiment, an acquaintance discount code input and generated by the user may be transmitted to another person, for example, one or more acquaintances, through an information transmission controller. According to a particular example, the acquaintance discount code may be transmitted in a message form through a terminal. According to another example, the acquaintance discount code may be individually or simultaneously sent to several SNS friends through the SNS. Therefore, the possibility of using the acquaintance discount code may be increased.

A person who has received the acquaintance discount code may easily check the acquaintance discount code to receive a discount to purchase an item on a related shopping website. In this case, purchase convenience of the person may be improved by using a link area connected to the shopping website.

Accordingly, the acquaintance discount code may be easily transmitted to the acquaintances and the possibility that the acquaintances purchase an item on the shopping website may be improved. The user may be allowed to easily accumulate a revenue reward to improve the shopping convenience and the possibility of increasing shopping on the shopping website may be improved. In addition, operation convenience and information confirmation convenience of each of the user generating the acquaintance discount code and other persons using the acquaintance discount code may be improved.

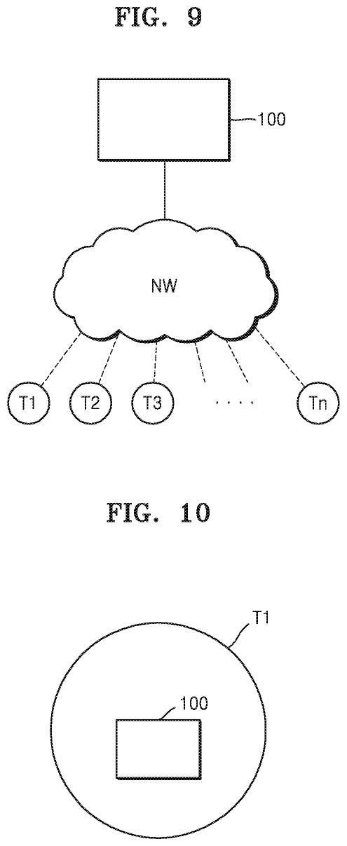

FIGS. 9 to 11 are diagrams of examples of a network connection of a shopping management control system 100 based on an acquaintance discount code according to an embodiment.

The shopping management control system 100 based on an acquaintance discount code of the present embodiment may be connected to a network in various forms.

According to an example, as shown in FIG. 9, the shopping management control system 100 based on an acquaintance discount code may be connected to each of the user's terminals T1, T2, . . . , and Tn through a plurality of networks. In other words, the shopping management control system 100 based on an acquaintance discount code or a modified configuration thereof may be distinguished from the user's terminal and connected to the network separately from the user's terminal. Herein, the user may include a company recruiting people or a job seeker.

According to another example, as shown in FIG. 10, the shopping management control system 100 based on an acquaintance discount code may be included in a user's terminal T1. There are various methods to include the shopping management control system 100 based on an acquaintance discount code of the present embodiment in a user's terminal. In an embodiment, each user may install the shopping management control system 100 based on an acquaintance discount code in a terminal through a network and store the shopping management control system 100 based on an acquaintance discount code in the terminal. For example, the shopping management control system 100 based on an acquaintance discount code may be installed in a user's terminal in a form of an application. Herein, the user may include a company recruiting people or a job seeker.

According to another example, as shown in FIG. 11, a portion 100A of the shopping management control system 100 based on an acquaintance discount code may be included in the user's terminal T1 and another portion 100B of the shopping management control system 100 based on an acquaintance discount code may be connected to the user's terminal T1 through a network. For example, the other portion 100B of the shopping management control system 100 based on an acquaintance discount code may include a server connected to the user's terminal through networks.

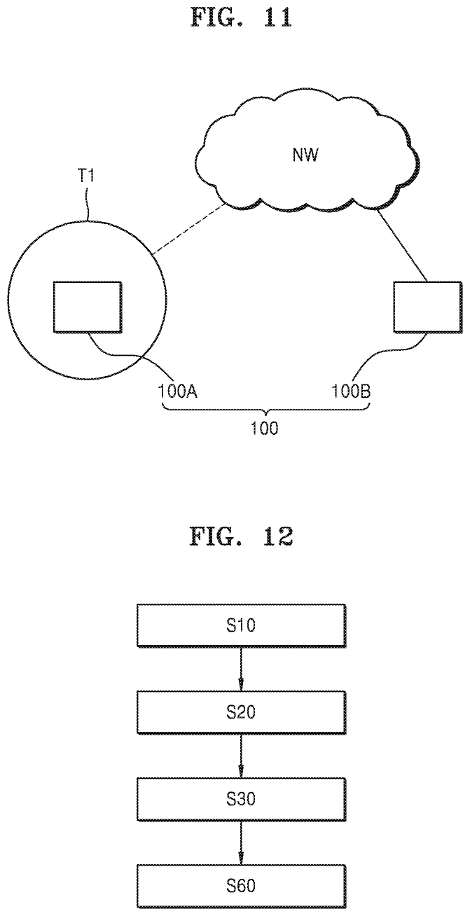

FIG. 12 is a schematic diagram of a shopping management control method based on an acquaintance discount code according to an embodiment.

Referring to FIG. 12, the shopping management control method based on an acquaintance discount code may include an input controlling operation S10, a management controlling operation S20, a display controlling operation S30, and a display controlling operation S60.

The shopping management control method based on an acquaintance discount code of the present embodiment may be used by a plurality of users. The shopping management control system 100 based on an acquaintance discount code may be used by one user and more than one acquaintances of the one user. Accordingly, an acquaintance discount code of the one user may be used by an acquaintance such as a friend of the one user to apply a discount to buy an item on a shopping webpage.

For example, the shopping management control method based on an acquaintance discount code may be used by a plurality of businesses to recruit people and may be used by a plurality of users to recruit jobs.

The shopping management control method based on an acquaintance discount code of the present embodiment will now be described in more detail.

In the input controlling operation S10, the user may recognize, according to a user's input, a piece of information included in an acquaintance discount code to be provided by a user.

For example, the user may input the piece of information included in the acquaintance discount code in a text form and the text may be recognized through the input controlling operation S10.

According to an embodiment, in the input controlling operation S10, a text input window may be displayed on a screen of a user's terminal and a character may be recognized when the user inputs the character on the text input window.

According to an embodiment, in the input controlling operation S10, a selection control window may be displayed and the selection control window may include various information blocks such as a plurality of characters, figures, pictures which may all be selected by the user. When the user selects the information block, for example, according to a touch of the block, the block may be recognized as an acquaintance discount code.

According to a further example, in the input controlling operation S10, the user may sequentially select a plurality of blocks through the selection control window and pieces of information which are included in each block and are sequentially connected may be recognized as an acquaintance discount code.

Accordingly, the user's input convenience may be improved.

In the management controlling operation S20, an acquaintance discount code of the user may be generated by reflecting the recognition in the input controlling operation S10 and the acquaintance discount code may be stored or managed.

In the management controlling operation S20, the acquaintance discount code may be generated by using the information of the user first recognized through the input controlling operation S10. For example, in the management controlling operation S20, the same information as the text input by the user through the input controlling operation S10 may be generated as an acquaintance discount code. According to a particular example, an acquaintance discount code may be generated by distinguishing between individual letters and spaces between letters or distinguishing between uppercase and lowercase letters.

According to an embodiment, the generated acquaintance discount code may be stored in the management controlling operation S20 and may be stored in the user's terminal. According to another example, the generated acquaintance discount code may be stored in a server separate from the user's terminal or a storage unit connected to the server.

According to an embodiment, in the management controlling operation S20, a modification item to change the acquaintance discount code of the user may be reflected when the user wants to modify the acquaintance discount code of the user, for example, real-time modification items may be reflected to update the acquaintance discount code of the user.

In this case, the modification of the acquaintance discount code of the user may be performed through the input controlling operation S10, for example, the modification may be performed by using the text input window or the like.

In the display controlling operation S30, the acquaintance discount code of the user generated through the management controlling operation S20 may be displayed on a screen of the user's terminal.

The user may view the acquaintance discount code displayed through the display controlling operation S30 and may also easily check the user's acquaintance discount code generated by the user's input.

According to an embodiment, the user may check the acquaintance discount code on a page of a shopping-providing website in the screen of the user's terminal and, in the display controlling operation S30, the acquaintance discount code may be displayed on a personal information page of the user among a plurality of pages of the shopping-providing website.

In addition, according to another example, in the display controlling operation S30, the acquaintance discount code of the user may be displayed on a first page that is displayed when the user logins among the plurality of pages of the shopping-providing website.

In addition, according to an embodiment, in the display controlling operation S30, feedback information may be displayed when the acquaintance of the user receives the acquaintance discount code of the user to purchase one or more items, for example, a purchase breakdown of the acquaintance may be displayed.

In addition, according to a further example, in the display controlling operation S30, the feedback information may be displayed when the acquaintance of the user receives the acquaintance discount code of the user to purchase one or more items, for example, a rewarding revenue that the user receives according to the purchase of the acquaintance may be displayed. According to a particular example, the rewarding revenue detailed breakdown and the reward income accumulation information may be displayed.

In the feedback controlling operation S60, when an item is purchased by receiving and applying the acquaintance discount code of the user, application information of the acquaintance discount code may be fed back to the user through one or more pieces of information.

For example, when an item is purchased by using the acquaintance discount code of the user, the feedback controlling operation S60 may allow the user to check purchase history information purchasing the item by using the acquaintance discount code of the user.

When one of the persons other than the user tries to apply the acquaintance discount code of the user on the shopping-providing website, according to a particular example, when an input is completed in a discount code input window, information with respect to the input may be informed to the user.

According to an example, when the one of the persons other than the user applies the acquaintance discount code of the user on the shopping-providing website, according to a particular example, when an input is completed in the discount code input window, information with respect to the input may be transmitted to the user through a message, and according to an embodiment, the information with respect to the input may be transmitted immediately after the input is completed.

According to another example, when the one of the persons other than the user applies the acquaintance discount code of the user on the shopping-providing website, according to a particular example, when an input is completed in the discount code input window, information with respect to the input may be displayed on the screen of the user's terminal, for example, the above-stated display controller 130 may be used to display the information with respect to the input.

In addition, according to an embodiment, when a plurality of acquaintances apply the acquaintance discount code of the user on the shopping-providing website or when one of the acquaintance applies the acquaintance discount code of the user on the shopping-providing website when purchasing a plurality of items, a plurality of purchase histories purchased by applying the acquaintance discount code of the user may be displayed on the screen of the user's terminal.

The user may easily figure out a use state of the acquaintance discount code of the user by checking various information and may figure out a tendency of the acquaintances by easily figuring out the purchases of the acquaintances, and also may actively share acquaintance discount codes.

According to another example, in the feedback controlling operation S60, when a person other than the user, for example, an acquaintance such as a friend of the user uses the acquaintance discount code of the user to purchase an item, a rewarding revenue may be provided to the user and the rewarding revenue may be displayed on the screen of the user's terminal to allow the user to check.

According to an example, when one of the persons other than the user applies the acquaintance discount code on the shopping-providing website, according to a particular example, when an input is completed in the discount code input window, predetermined rewarding revenue may be provided to the user and displayed on the screen of the user's terminal.

According to an embodiment, a payment of the reward to the user may be completed after going through a payment schedule stage, for example, when other person uses the acquaintance discount code of the user to decide to purchase an item, it is set to a “reward payment schedule stage”. When the other person completes a final normal payment, the “reward payment schedule stage” is changed to a “reward payment completion” stage and actual rewarding revenue may be paid to the user. In addition, processes of each stage may be distinguished according to time and may be displayed on the screen of the user's terminal.

According to a particular example, in the display controlling operation S30, various contents related to the rewarding revenue may be displayed.

In addition, according to an embodiment, when the plurality of acquaintances apply the acquaintance discount code on the shopping-providing website or when one of the acquaintances applies the acquaintance discount code on the shopping-providing website when purchasing a plurality of items, a plurality of rewarding revenue histories may be sequentially displayed to allow the user to check and the user may check an accumulative rewarding revenue over a certain period of time. According to an example, in the display controlling operation S30, the rewarding revenue history and the accumulative rewarding revenue may be displayed on the screen of the user's terminal.

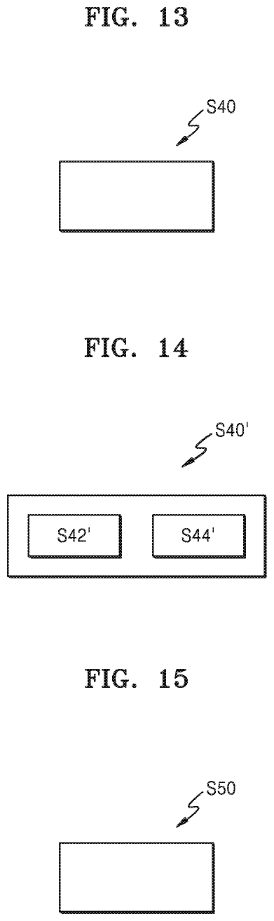

FIG. 13 is a diagram of an information transmission controlling operation S40 which may be added to the shopping management control method based on an acquaintance discount code in FIG. 12 according to an embodiment.

Referring to FIG. 13, the shopping management control method based on an acquaintance discount code of the present embodiment may further include the information transmission controlling operation S40.

The user may transmit the acquaintance discount code to other persons through the information transmission controlling operation S40. For example, the user may transmit information of the acquaintance discount code generated by the user to one or more or a plurality of acquaintances through the information transmission controlling operation S40.

Other persons received the information of the acquaintance discount code of the user through the information transmission controlling operation S40 may use the acquaintance discount code of the user to purchase a desired item at a discount prince according to a set discount rate.

According to an embodiment, in the information transmission controlling operation S40, the acquaintance discount code of the user may be transmitted to another person through the user's terminal and respectively transmitted to desired acquaintances, according to another example, the acquaintance discount code of the user may be simultaneously transmitted to a plurality of acquaintances.

FIG. 14 is a diagram of the information transmission controlling operation S40′ in FIG. 13 according to an embodiment;

Referring to FIG. 14, the information transmission controlling operation S40′ may include a message controlling operation S42′ or a social network services controlling operation S44′.

In the message controlling operation S42′, the acquaintance discount code may be transmitted to another person in a form of a message.

For example, the user may use the user's terminal to include the acquaintance discount code of the user into a message and transmit the message through the message controlling operation S42′. In this case, the message controlling operation S42′ may include a text input operation recognizing the acquaintance discount code of the user when the acquaintance discount code of the user is input in a form of a text.

According to an embodiment, when the user intends to choose an option to transmit the acquaintance discount code, after choosing only the user's desired acquaintances, the acquaintance discount code information may be transmitted to the desired acquaintances without a text input of the acquaintance discount code in the message controlling operation S42′, thereby improving the user's convenience.

In the SNS controlling operation S44′, the acquaintance discount code may be transmitted to a SNS acquaintance. According to an embodiment, in the SNS controlling operation S44′, the acquaintance discount code may be transmitted to another person through one or more of a plurality of SNSs in which the user is active.

For example, the user may transmit the information of the acquaintance discount code generated by the user to acquaintances who have a relationship with the user in one or more SNSs through the SNS controlling operation S44′. In this case, in the SNS controlling operation S44′, the acquaintance discount code may be directly transmitted to the acquaintances without a text input included in the information of the acquaintance discount code of the user such that the acquaintances may check the acquaintance discount code.

FIG. 15 is a diagram of a reception display controlling operation S50 which may be added to the shopping management control method based on an acquaintance discount code in FIG. 12.

Referring to FIG. 15, the shopping management control method based on an acquaintance discount code may further include a reception display controlling operation S50.

In the reception display controlling operation S50, when the user transmits the acquaintance discount code of the user generated by the user to at least one person, for example, an acquaintance, a fact of the transmission may be displayed on the screen of the user's terminal.

For example, in the reception display controlling operation S50, the acquaintance discount code generated by the user may be originally displayed on the screen of an acquaintance's terminal.

According to an embodiment, in the reception display controlling operation S50, information of a shopping-providing website, which may receive a discount on an item by applying the information of the acquaintance discount code, may be displayed on the screen of the acquaintance's terminal. According to a particular example, a link area connected to one page among a plurality of pages of a shopping-providing website may be displayed such that the acquaintance may select the link area to immediately move to a screen of the shopping-providing website to check items that may be able to be purchased from the shopping-providing website.

Accordingly, the acquaintance who has received the acquaintance discount code from the user may easily check the information of the acquaintance discount code and may easily figure out website information that may receive a discount on an item by using the acquaintance discount code. In addition, usage convenience with respect to the acquaintance discount code may be improved such that a discount application of an acquaintance may be easy and shopping convenience may be improved.

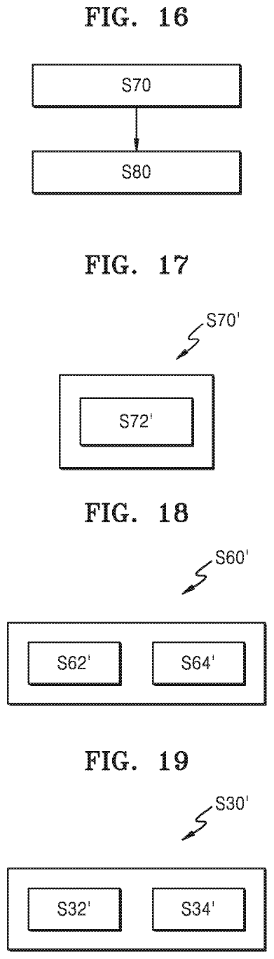

FIG. 16 is a diagram of a code input receiving operation S70 and a discount applying operation S80 which may be added to the shopping management control method based on an acquaintance discount code in FIG. 12.

Referring to FIG. 5, the shopping management control method based on an acquaintance discount code may further include the code input receiving operation S70 and the discount applying operation S80.

The acquaintance of the user who has received the acquaintance discount code generated by the user may use the acquaintance discount code when purchasing an item on a shopping website. According to a particular example, discounts may be received by applying the acquaintance discount code.

In this case, the acquaintance who intends to use the acquaintance discount code of the user may need to input the acquaintance discount code during a purchase stage when purchasing an item on the shopping website and in the code input receiving operation S70, the input of the acquaintance discount code of the use may be recognized.

For example, in the code input receiving operation S70, an input content may be recognized when the acquaintance of the user inputs the acquaintance discount code of the user in which the acquaintance knows in the text input window in a text form.

When the acquaintance uses the acquaintance discount code on the shopping website to perform the purchase stage with respect to an item, in the discount applying operation S80, a discount rate corresponding to the acquaintance discount code may be applied on the one item to perform the purchase stage with a discount price.

In this case, the discount rate may be a preset discount rate, for example, 5% of an original selling price of an item.

According to an embodiment, the discount rate may be changed from the present discount rate when a condition is satisfied. For example, the discount rate may be increased according to accumulative revenue of the user who generates the acquaintance discount code. In detail, when items purchased by applying the acquaintance discount code of the user increase, a preset incremental discount rate may be applied.

FIG. 17 is a diagram of an embodiment of a code input receiving operation S70′ in FIG. 16.

Referring to FIG. 17, the code input receiving operation S70′ may include a matching controlling operation S72′. In the matching controlling operation S72′, it may be determined whether an acquaintance discount code input by the acquaintance is normal. According to another example, it may be determined whether the input is an acquaintance discount code or an acquaintance discount code generated by the user.

The acquaintance of the user who has received the acquaintance discount code generated by the user may use the acquaintance discount code when purchasing an item on a shopping website. According to a particular example, discounts may be received by applying the acquaintance discount code.

In this case, the acquaintance who intends to use the acquaintance discount code of the user may need to input the acquaintance discount code during a purchase stage when purchasing an item on the shopping website and in the code input receiving operation S70′, the input of the acquaintance discount code of the use may be received and recognized.

For example, in the code input receiving operation S70′, an input content may be recognized when the acquaintance of the user inputs the acquaintance discount code of the user in which the acquaintance knows in the text input window in a text form.

In this case, in the matching controlling operation S72′, the information input by the acquaintance may be determined whether is the acquaintance discount code. According to an embodiment, in the matching controlling operation S72′, the information input by the acquaintance may be determined whether matches one of a plurality of acquaintance discount codes which are pre-stored. In this case, the determination of whether characters of the input information matches, spaces between characters, or distinguishing between lowercase and upper case letters may be used to determine whether the input information is the acquaintance discount code.

In addition, according to an embodiment, a matching result may be displayed on the screen of the acquaintance's terminal after the input is completed, for example, when the input information does not match the acquaintance discount code, a result may be displayed to notify that a discount may not be applied.

In addition, according to an embodiment, in the matching controlling operation S72′, the information input by the acquaintance may be determined whether is the acquaintance discount code information generated by the acquaintance own. In this case, the matching result may be displayed on the screen of the acquaintance's terminal, for example, as a notice that the acquaintance inputs his/her acquaintance discount code, or a notice that a discount may not be applied may also be displayed.

FIG. 18 is a diagram of a feedback controlling operation S60′ of the shopping management control method based on an acquaintance discount code in FIG. 12, according to an embodiment.

Referring to FIG. 18, the feedback controlling operation S60′ may include a purchase breakdown information controlling operation S62′ and a revenue information controlling operation S64′.

According to an embodiment, the feedback controlling operation S60′ may include one of the purchase breakdown information controlling operation S62′ and the revenue information controlling operation S64′.

When the acquaintance discount code generated by the user is used by a person other than the user, for example, an acquaintance and when the acquaintance uses the acquaintance discount code to apply a discount to purchase an item, in the purchase breakdown information controlling operation S62′, information with respect to the purchase breakdown may be managed and stored. According to an embodiment, the information with respect to the purchase breakdown may be notified to the user, for example, the information with respect to the purchase breakdown may be displayed on the screen of the user's terminal. Accordingly, the user may easily figure out how much of the acquaintance's purchase corresponds to the acquaintance discount code generated by the user or which acquaintance purchased items by using the acquaintance discount code.

When the acquaintance discount code generated by the user is used by a person other than the user, for example, an acquaintance and when the acquaintance uses the acquaintance discount code to apply a discount to purchase an item, in the revenue information controlling operation S64′, the providing of a preset rewarding revenue to the user may be controlled. Accordingly, the user may be more actively transmit his/her acquaintance discount code to the acquaintances. Accordingly, when more acquaintances apply the acquaintance discount code of the user, the rewarding revenue may be increased.

According to an embodiment, in the revenue information controlling operation S64′, a payment of the reward may be allowed to be completed at one time. According to another example, in the revenue information controlling operation S64′, the payment of the reward to the user may be allowed to be completed after a payment schedule stage.

For example, when another person determines to use the acquaintance discount code of the user to purchase an item, it may be set as a “reward payment schedule stage” and after a final normal payment of the other person is completed, the “reward payment schedule stage” may be changed to a “reward payment completion” stage and an actual rewarding revenue may be paid to the user. In addition, processes of each stage may be distinguished according to time and may be displayed on the screen of the user's terminal.

As a result, the shopping convenience on the shopping websites may be improved and the shopping opportunities may be increased to increase purchase of items on the shopping websites.

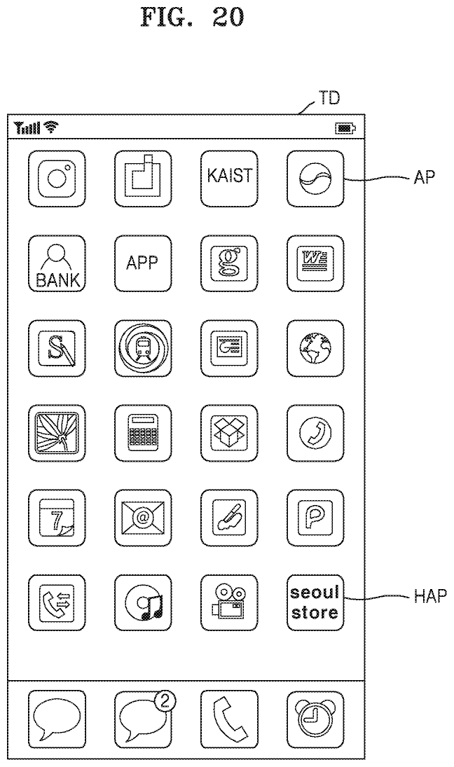

FIG. 19 is a diagram of a display controlling operation S30′ of the shopping management control method based on an acquaintance discount code in FIG. 12 according to an embodiment.

Referring to FIG. 19, the display controlling operation S30′ may include a purchase breakdown display controlling operation S32′ and a revenue information display controlling operation S34′.

According to an embodiment, the display controlling operation S30′ may include one of the purchase breakdown display controlling operation S32′ and the revenue information display controlling operation S34′.

When the acquaintance discount code generated by the user is used by a person other than the user, for example, an acquaintance and when the acquaintance uses the acquaintance discount code to apply a discount to purchase an item, in the purchase breakdown display controlling operation S32′, information with respect to the purchase breakdown may be managed and the information with respect to the purchase breakdown may be displayed on the screen of the user's terminal.

Accordingly, the user may easily figure out how much of the purchase was made by using the acquaintance discount code generated by the user or who of the acquaintances purchases items by using the acquaintance discount code.

According to an embodiment, in the purchase breakdown display controlling operation S32′, a list of the purchase breakdown may be displayed on the screen of the user's terminal and may an accumulative result of the purchase breakdown in a certain period of time may be displayed.

When the acquaintance discount code generated by the user is used by a person other than the user, for example, an acquaintance and when the acquaintance uses the acquaintance discount code to apply a discount to purchase an item, preset rewarding revenue may be provided to the user.

According to an embodiment, a payment of the reward may be completed at one time. According to another example, the payment of the reward to the user may be completed after the payment schedule stage.

For example, when another person determines to use the acquaintance discount code of the user to purchase an item, it may be set as a “reward payment schedule stage” and after a final normal payment of the other person is completed, the “reward payment schedule stage” may be changed to a “reward payment completion” stage and an actual rewarding revenue may be paid to the user. In addition, processes of each stage may be distinguished according to time and may be displayed on the screen of the user's terminal.

As a result, the shopping convenience on the shopping websites may be improved and the shopping opportunities may be increased to increase purchase of items on the shopping websites.

In addition, in the revenue information display controlling operation S34′, the rewarding revenue may be displayed on the screen of the user's terminal to allow the user to check.

According to an example, when one of the persons other than the user applies the acquaintance discount code on the shopping-providing website, according to a particular example, when an input is completed in the discount code input window, a predetermined rewarding revenue may be provided to the user and the rewarding revenue may be displayed on the screen of the user's terminal.

In addition, when the rewarding revenue is paid to the user stage by stage, the rewarding revenue for each stage may be distinguished and displayed on the screen of the user's terminal through the revenue information display controlling operation S34′.

In addition, an accumulative breakdown of the rewarding revenue may be displayed in accordance with time through the revenue information display controlling operation S34′.

In addition, according to an embodiment, the rewarding revenue may be displayed in connection with a type of purchase, that is, a purchase type of the acquaintance.

The shopping management control method based on an acquaintance discount code of the present embodiment may include an input controlling operation to recognize the user's acquaintance discount code input by the user and in a management controlling operation, an acquaintance discount code of the user may be generated and managed.

In addition, in a display controlling operation, the acquaintance discount code of the user may be displayed through the screen of the user's terminal to allow the user to check. Accordingly, the user may easily check the acquaintance discount code input and generated by the user and may check the displayed content to modify when needed.

When another person uses the acquaintance discount code of the user to receive a discount to purchase an item, feedback reflecting information about the purchase may be performed through a feedback controlling operation.

For example, feedback of information with respect to a purchase fact may be performed and feedback of information with respect to rewarding revenue that the user may obtain through the purchase may be performed. In this case, according to an embodiment, the feedback content may be displayed on the screen of the user's terminal and the user may easily figure out a use of the acquaintance discount code of the user and a revenue content of the user with respect to the use of the acquaintance discount code.

In addition, according to an embodiment, an acquaintance discount code input and generated by the user may be transmitted to another person, for example, one or more acquaintances, in an information transmission controlling operation. According to a particular example, the acquaintance discount code may be transmitted in a message form through a terminal. According to another example, the acquaintance discount code may be individually or simultaneously sent to several SNS friends through the SNS. Therefore, the possibility of using the acquaintance discount code may be increased.

A person who has received the acquaintance discount code may easily check the acquaintance discount code to receive a discount to purchase an item on a related shopping website. In this case, purchase convenience of the person may be improved by using a link area connected to the shopping website.

Accordingly, the acquaintance discount code may be easily transmitted to the acquaintances and the possibility that the acquaintances purchase an item on the shopping website may be improved. The user may be allowed to easily accumulate a revenue reward to improve the shopping convenience and the possibility of increasing shopping on the shopping website may be improved. In addition, operation convenience and information confirmation convenience of each of the user generating the acquaintance discount code and other persons using the acquaintance discount code may be improved.

According to an embodiment, a payment of the reward to the user may be completed after going through a payment schedule stage, for example, when other person uses the acquaintance discount code of the user to decide to purchase an item, it is set to a “reward payment schedule stage”. When the other person completes a final normal payment, the “reward payment schedule stage” is changed to a “reward payment completion” stage and actual rewarding revenue may be paid to the user. In addition, processes of each stage may be distinguished according to time and may be displayed on the screen of the user's terminal.

According to an embodiment, various contents related to the rewarding revenue may be displayed by using the display controlling operation S30.

In addition, according to an embodiment, when the plurality of acquaintances apply the acquaintance discount code on the shopping-providing website or when one of the acquaintances applies the acquaintance discount code on the shopping-providing website when purchasing a plurality of items, a plurality of rewarding revenue histories may be sequentially displayed to allow the user to check and the user may check an accumulative rewarding revenue over a certain period of time. According to an example, the rewarding revenue history and the accumulative rewarding revenue may be displayed on the screen of the user's terminal by using the display controlling operation S30.

FIGS. 20 to 30 are diagrams of a shopping management control method based on an acquaintance discount code according to an embodiment.

Referring to FIG. 20, a screen TD of a user's terminal is illustrated. Icons AP on which one or more applications perform operations may be displayed on the screen TD.

The shopping management control method based on an acquaintance discount code of the present embodiment may be implemented through functions of applications of the user's terminal, for example, the method may be started through an icon HAP displayed on the screen TD.

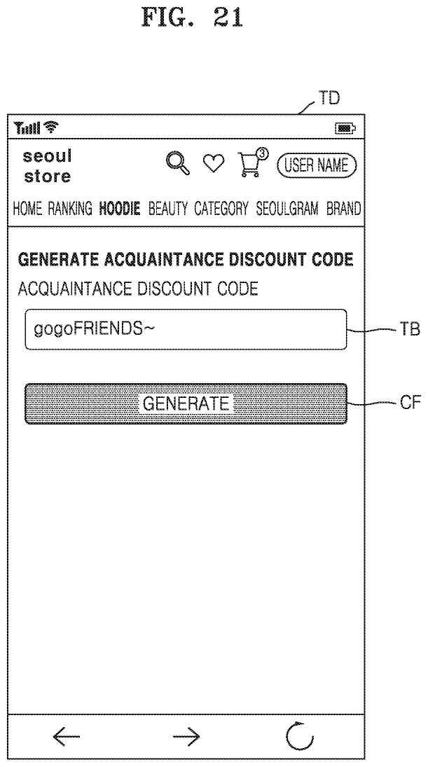

Referring to FIG. 21, an acquaintance discount code input area TB is illustrated on the screen TD of the user's terminal. For example, the user may input his/her acquaintance discount code into the acquaintance discount code input area TB. According to a particular example, the acquaintance discount code may be input in a text form. According to an embodiment, the acquaintance discount code may be input by distinguishing lowercase letters and uppercase letters and may be input by including special characters.

When the user completes inputting his/her acquaintance discount code into the acquaintance discount code input area TB, the input may be completed by using a determination unit CF. Accordingly, information input by the user in the acquaintance discount code input area TB may be generated and stored as an acquaintance discount code of the user.

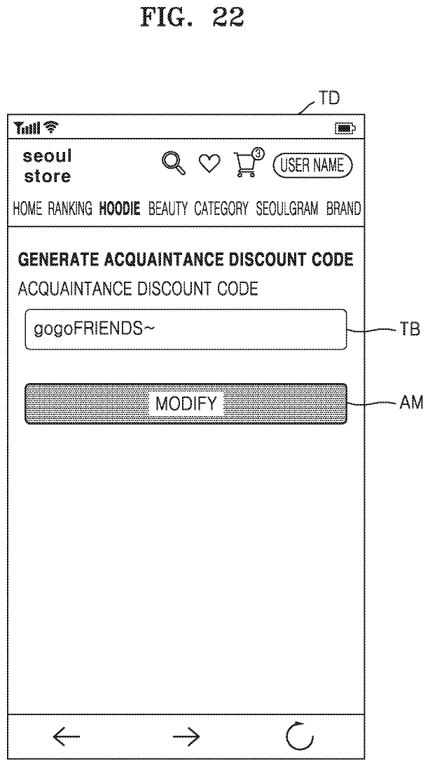

The user may store the acquaintance discount code after generating the acquaintance discount code. Referring to FIG. 22, the acquaintance discount code input area TB is shown on the screen TD of the user's terminal and after the user inputs his/her acquaintance discount code into the acquaintance discount code input area TB, a modification may be completed by using a modification confirmation unit AM.

In addition, according to an embodiment, a modification input may be implemented when desired by the user. The acquaintance discount code may be modified and stored according to the modification input of the user.

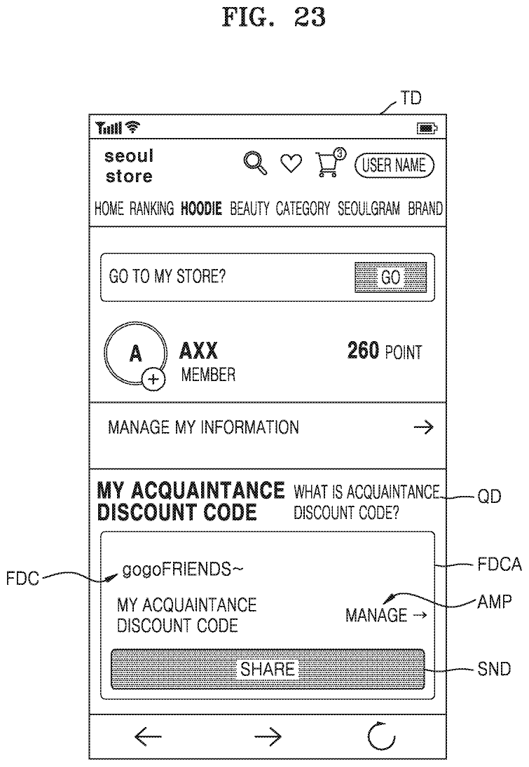

Referring to FIG. 23, an acquaintance discount code FDC generated by the user is displayed on the screen TD of the user's terminal.

According to an embodiment, the acquaintance discount code FDC may be included and displayed in an acquaintance discount code area FDCA. The acquaintance discount code area FDCA may be displayed as a distinct area on the screen TD of the user's terminal, for example, the acquaintance discount code area FDCA may be displayed in a different color than adjacent areas. According to an embodiment, the acquaintance discount code area FDCA may have a shape similar to a rectangular form of a credit card.

A name of the user (for example, AXX) may be displayed in an area adjacent to the acquaintance discount code area FDCA. A portion of the name of the user (for example, A) may be displayed as an icon.

According to an embodiment, an explanation performing unit QD with respect to the acquaintance discount code FDC or the acquaintance discount code area FDCA may be displayed to be adjacent to the acquaintance discount code area FDCA and an explanation area may be displayed when the explanation performing unit QD is selected.

According to an embodiment, an acquaintance discount code management selecting unit AMP may be displayed in the acquaintance discount code area FDCA. When the acquaintance discount code management selection unit AMP is selected, the user may perform management operation with respect to his/her acquaintance discount code, for example, the user may perform modification operation as shown in FIG. 22.

According to an embodiment, a transmission unit SND may be included in the acquaintance discount code area FDCA. For example, the user may transmit his/her acquaintance discount code FDC to a desired acquaintance through the transmission unit SND.

For example, the user may transmit his/her acquaintance discount code FDC to the desired acquaintance by using a transmission function through the transmission unit SND. According to an embodiment, when the transmission unit SND is selected, an address book page of the user's terminal may be displayed and when the user selects the desired acquaintance, a text entry window may be activated with the acquaintance discount code FDC copied therein, and upon confirmation of the user, a text message including the acquaintance discount code FDC may be sent to the acquaintance selected by the user.

According to another example, the user may transmit the acquaintance discount code FDC of the user to acquaintances who have a relationship in SNS that the user uses through the transmission unit SND.

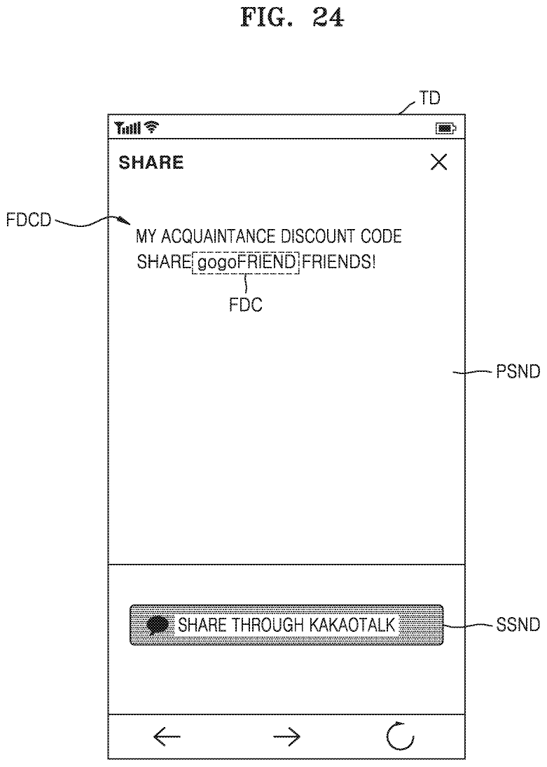

According to a particular example, when the transmission unit SND is selected, as shown in FIG. 24, a SNS transmission page PSND may be displayed on the screen TD of the user's terminal. A SNS selecting unit SSND in which the user may selects one or more SNSs used by the user is displayed in the sNS transmission page PSND. For example, FIG. 24 illustrates only one SNS selecting unit SSND, but a plurality of SNS selecting units of different types may be displayed to allow the user to select.

In addition, according to an embodiment, an acquaintance discount code checking area FDCD may be displayed on the SNS transmission page PSND such that the acquaintance discount code of the user may be checked.

When the user selects the SNS selecting unit SSND, the user may select a desired acquaintance in a SNS that the user uses and when the acquaintance is selected, information of the acquaintance discount code FDC may be transmitted without separate input by the user (additionally, the user may make an input).

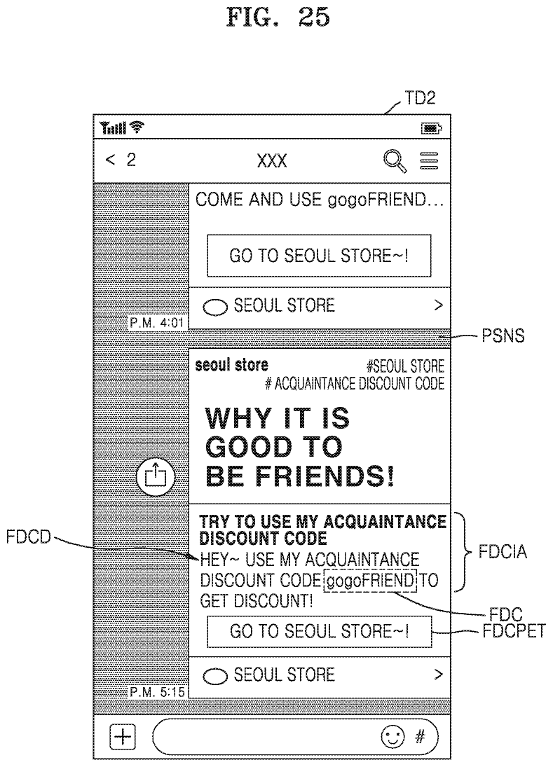

For example, as shown in FIG. 25, an acquaintance discount code information area FDCIA including the acquaintance discount code FDC transmitted by the user may be transmitted to a screen TD2 of a terminal of an acquaintance selected by the user. According to an embodiment, the acquaintance discount code information area FDCIA may be transmitted through a SNS message page PSNS.

In this case, according to an embodiment, a shopping website link unit FDCPET may be displayed to be adjacent to the acquaintance discount code information area FDCIA. The shopping website link unit FDCPET may be a link unit that induces an entry of a shopping website that may receive a discount to purchase an item by using the acquaintance discount code FDC included in the acquaintance discount code information area FDCIA.

In addition, the shopping website link unit FDCPET may induce an entry of a shopping website that provides an acquaintance discount code to the user to generate an acquaintance discount code.

After checking the acquaintance discount code information area FDCIA in FIG. 25, the acquaintance may visit a shopping website and perform shopping. For example, shopping may be easily performed without specific address information of the shopping website by selecting the shopping website link unit FDCPET shown in FIG. 25.

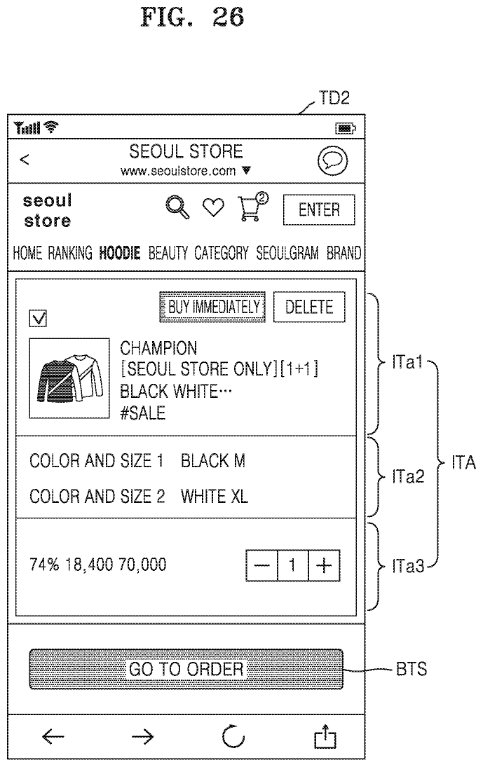

For example, the acquaintance may perform an ordering process with respect to one or more items, as shown in FIG. 26. FIG. 26 shows an item information area including item information ITA that the acquaintance desires to purchase according to an ordering stage.

According to an embodiment, the item information ITA may include a plurality of item information areas ITa1 , ITa2, and ITa3, and detailed information of the items may be distinguished and displayed through each of the plurality of item information areas ITa1 , ITa2, and ITa3.

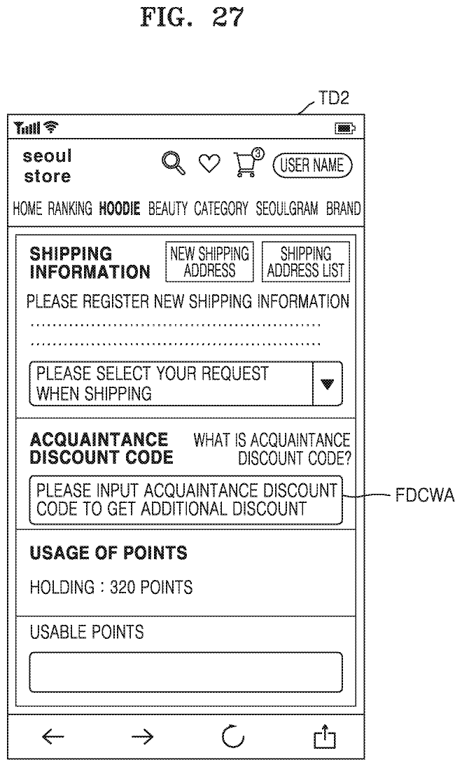

When an ordering selection BTS is selected to perform ordering, as shown in FIG. 27, an acquaintance discount code input area FDCWA may be displayed on the screen TD2 of the terminal of the acquaintance.

The acquaintance may input an acquaintance discount code that the acquaintance knows, for example, the acquaintance discount code FDC of the acquaintance discount code information area FDCIA received from the user through the SNS message page PSNS as shown in FIG. 25, in to the acquaintance discount code input area FDCWA.

When the acquaintance inputs an acquaintance discount code that the acquaintance knows into the acquaintance discount code input area FDCWA, the acquaintance may receive a discount with respect to an item that the acquaintance desires to purchase and has an ordering stage. According to an embodiment, an acquaintance discount code matching operation may be performed.

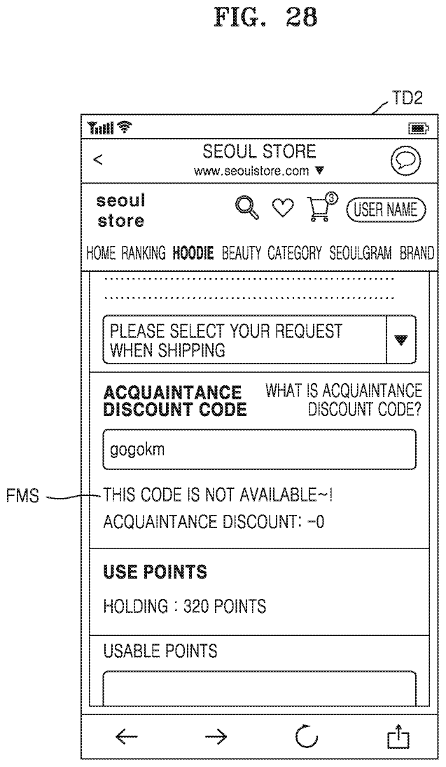

For example, as shown in FIG. 28, when the acquaintance discount code input in the acquaintance discount code input area FDCWA by the acquaintance does not exist, that is, when the acquaintance discount code is entered incorrectly, a discount may not be applied and an error message FMS may be displayed.

In addition, according to an embodiment, when the acquaintance inputs the acquaintance discount code generated by the acquaintance into the acquaintance discount code input area FDCWA, a discount may not be applied, in which case, an error message (not shown in the figure) indicating that an own code may not receive a discount may be displayed.

When the acquaintance of the user who has received the acquaintance discount code of the user purchases an item on a shopping website, the acquaintance discount code may be applied to receive a discount. Accordingly, the user transmitted the acquaintance discount code may receive feedback with respect to the purchase of the acquaintance. For example, when the acquaintance uses the acquaintance discount code to purchase an item, the user may receive information with respect to a purchase fact.

In addition, when the acquaintance uses the acquaintance discount code to purchase an item, the user may receive rewarding revenue and the rewarding revenue may be a predetermined amount set in advance. According to another example, the rewarding revenue may be a preset amount in proportion to a price of an item purchased by using the acquaintance discount code.

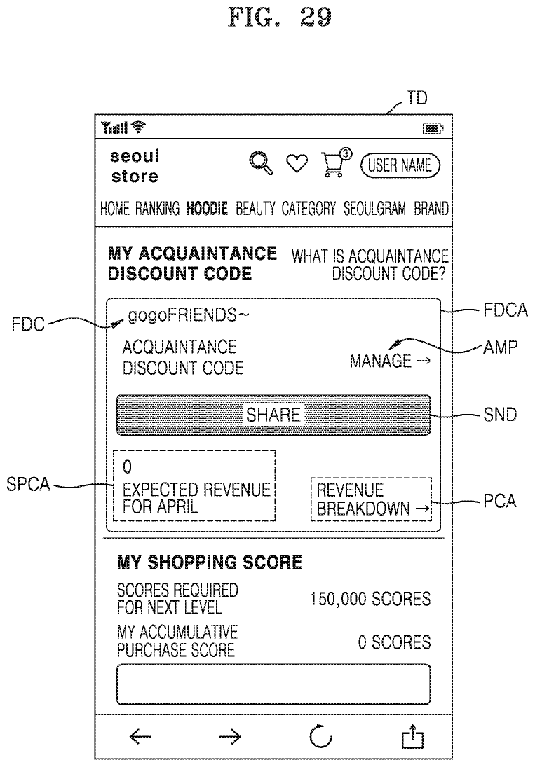

According to an embodiment, as shown in FIG. 29, the acquaintance discount code area FDCA may be displayed in the screen TD of the user's terminal and a rewarding revenue history SPCA may be displayed in the acquaintance discount code area FDCA. For example, the rewarding revenue history SPCA may show accumulative rewarding revenue in a set period of time. According to a particular example, the accumulative rewarding revenue of the current month may be shown (for example, 0 in FIG. 29).

According to an embodiment, a rewarding revenue information display selecting unit PCA may be displayed in the acquaintance discount code area FDCA. When the user selects the rewarding revenue information display selecting unit PCA, the user may check detailed information with respect to the rewarding revenue of the user.

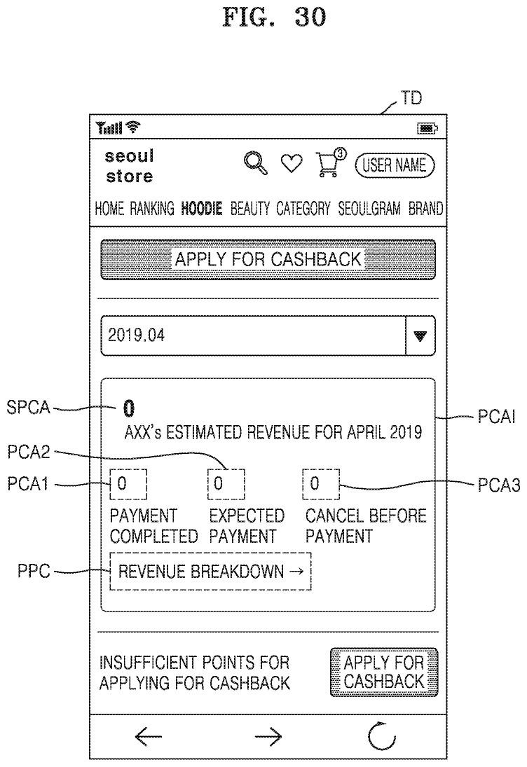

For example, a rewarding revenue information display area PCAI may be displayed in the screen TD of the user's terminal shown in FIG. 30.

One or more rewarding revenue information detailed areas PCA1, PCA2, and PCA3 may be displayed in the rewarding revenue information display area PCAI.

For example, when the acquaintance of the user uses the acquaintance discount code transmitted by the user to purchase an item on a shopping website, rewarding revenue may be provided to the user. The rewarding revenue may be provided through a plurality of stages rather than being provided just once.

According to an example, when an order to purchase an item by using the acquaintance discount code is completed, rewarding revenue to be temporarily provided in accordance with a payment schedule stage may be displayed in the rewarding revenue information detailed area PCA2.

Then, when return or exchange of an item purchased is not performed and the ordering stage is maintained until a predetermined period of time passes, such as a period for the return, exchange, or the like, a payment of the rewarding revenue at the payment schedule stage may be confirmed and revenue content may be displayed in the rewarding revenue information detailed area PCA1.

Alternatively, according to another example, when the return or the exchange of the item is performed and the ordering stage is cancelled before a predetermined period time passes, such as a period for the return and the exchange of the item purchased or the like, the rewarding revenue of the payment schedule stage may be cancelled before the payement and the revenue content may be displayed in the rewarding revenue information detailed area PCA3.

According to an embodiment, a rewarding revenue detailed list selecting unit PPC may be included and displayed. When the user selects the rewarding revenue detailed list selecting unit PPC, a list about accumulation of rewarding revenues, such as purchases of the acquaintances and rewarding revenues corresponding to the purchases of the acquaintances may be matched and displayed on the screen TD of the user's terminal. The list about the accumulation of the rewarding revenues may be displayed by arranging the rewarding revenues in a time order.

Accordingly, when the acquaintance uses the acquaintance discount code of the user to purchase an item, the user may receive rewarding revenue of a preset amount. According to an embodiment, when the number of times of using the acquaintance discount code is accumulated and exceeds a set number of times, the user may receive higher rewarding revenue than the rewarding revenue received in an initial application. Accordingly, the user's desire to transmit the acquaintance discount code of the user to an acquaintance may be increased and a utilization rate of the shopping website may be improved.

In addition, the user may easily check each purchase of an acquaintance using the acquaintance discount code and the accumulation of the rewarding revenue may be easily checked. According to an embodiment, a payment for each stage may be easily checked.

Although the present disclosure has been described with reference to the embodiments shown in the drawings, the embodiments are merely exemplary and it is apparent to those skilled in the art that various modifications and other equivalent embodiments are possible therefrom. It will be understood by those of ordinary skill in the art that various changes in form and details may be made therein without departing from the spirit and scope as defined by the following claims.

The present disclosure may be described in terms of functional block components and various processing steps. Such functional blocks may be realized by any number of hardware and/or software components configured to perform the specified functions. For example, the embodiments may employ various integrated circuit (IC) components, e.g., memory elements, processing elements, logic elements, look-up tables, and the like, which may carry out a variety of functions under the control of one or more microprocessors or other control devices.

Similarly, where the elements are implemented using software programming or software elements, the present disclosure may be implemented with any programming or scripting language such as C, C++, Java, assembler language, or the like, with the various algorithms being implemented with any combination of data structures, objects, processes, routines or other programming elements. Functional aspects may be implemented in algorithms that are executed on one or more processors. Furthermore, the embodiments could employ any number of conventional techniques for electronics configuration, signal processing and/or control, data processing and the like. The words “mechanism,” “element,” “means,” and “configuration” are used broadly and are not limited to mechanical or physical embodiments, but can include software routines in conjunction with processors, etc. The term may include the meaning of a series of routines of software in conjunction with a processor or the like.

The particular implementations shown and described herein are illustrative examples of the inventive concept and are not intended to otherwise limit the scope of the inventive concept in any way. For the sake of brevity, conventional electronics, control systems, software development and other functional aspects of the systems may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the inventive concept unless the element is specifically described as “essential” or “critical”.

The use of the terms “a” and “an” and “the” and similar referents in the context of describing the inventive concept (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the steps of all methods described herein can be performed in any suitable order unless otherwise indicated herein or otherwise clearly contradicted by context. The present disclosure is not limited to the described order of the steps. The use of any and all examples, or exemplary language (e.g., “such as”) provided herein, is intended merely to better illuminate the inventive concept and does not pose a limitation on the scope of the inventive concept unless otherwise claimed. Numerous modifications and adaptations will be readily apparent to one of ordinary skill in the art without departing from the spirit and scope.

The shopping management control system based on an acquaintance discount code and the shopping management control method based on an acquaintance discount code according to the present embodiment may improve shopping convenience of a user who has generated the acquaintance discount code and acquaintances using the acquaintance discount code.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

We claim:

1. A shopping management control system based on an acquaintance discount code, the system comprising:
an input controller configured to recognize information in an acquaintance discount code to be provided by a user according to an input of the user;
a management controller configured to determine that the input controller recognized the information to generate an acquaintance discount code of the user, and store and manage the acquaintance discount code of the user;
a display controller configured to display the acquaintance discount code of the user generated through the management controller on a screen of a terminal of the user; and
a feedback controller configured to feed back, when the acquaintance discount code of the user is received and an item is purchased by using the acquaintance discount code, one or more pieces of application information of the acquaintance discount code to the user.

2. The system of claim 1, wherein
the acquaintance discount code is used on a shopping-providing website, and
the display controller is further configured to display information of the acquaintance discount code of the user on a page among a plurality of pages of the shopping-providing website.

3. The system of claim 1, wherein,
when the acquaintance discount code is used to purchase an item, the feedback controller is further configured to provide rewarding revenue to the user.

4. The system of claim 1, wherein
the acquaintance discount code is used on a shopping-providing website, and
an input area to input the acquaintance discount code is displayed on a page among a plurality of pages of the shopping-providing website.

5. The system of claim 1, further comprising
a reception display controller configured to display information of the acquaintance discount code on a screen of a terminal of an acquaintance of the user, wherein the acquaintance receives the acquaintance discount code.

6. A shopping management control method based on an acquaintance discount code, the method comprising:
an input controlling operation for recognizing information comprised in an acquaintance discount code to be provided by a user according to an input of the user;
a management controlling operation for reflecting the recognizing in the input controlling operation to generate an acquaintance discount code of the user and storing and managing the acquaintance discount code of the user;
a display controlling operation for displaying the acquaintance discount code of the user generated through the management controlling operation on a screen of a terminal of a user; and
a feedback controlling operation for feeding back, when the acquaintance discount code of the user is received and an item is purchased by using the acquaintance discount code, application information of the acquaintance discount code to the user through one or more information.

7. The method of claim 6, wherein
the acquaintance discount code is used on a shopping-providing website, and
the acquaintance discount code of the user is displayed in the display controlling operation on a page among a plurality of pages of the shopping-providing website.

8. The method of claim 6, wherein,
when the acquaintance discount code is used to purchase an item, the feedback controlling operation further comprises providing rewarding revenue to the user.

9. The method of claim 6, wherein
the acquaintance discount code is used on a shopping-providing website, and
an input area to input the acquaintance discount code is displayed on s page among a plurality of pages of the shopping-providing website.

10. The method of claim 6, further comprising
a reception display controlling operation for displaying information of the acquaintance discount code on a screen of a terminal of an acquaintance of the user, wherein the acquaintance receives the acquaintance discount code.

11. A computer-readable recoding medium having recorded thereon a program for performing the method of claim 6.
